(19) United States
(12) Patent Application Publication
(10) Pub. No.: US 2023/0202917 A1
(43) Pub. Date: Jun. 29, 2023

(54) GLASS

(71) Applicant: HOYA CORPORATION, Tokyo (JP)

(72) Inventors: Yoshitake TANNO, Tokyo (JP); Mikio IKENISHI, Tokyo (JP)

(73) Assignee: HOYA CORPORATION, Tokyo (JP)

(21) Appl. No.: 18/089,069

(22) Filed: Dec. 27, 2022

(30) Foreign Application Priority Data
Dec. 28, 2021 (JP) 2021-215019
Dec. 22, 2022 (JP) 2022-205459

(51) Int. Cl. C03C 23/00; C03C 3/21; G02B 1/00

(52) U.S. Cl. CPC C03C 23/00; C03C 3/21; G02B 1/00

(57) ABSTRACT

Glass comprising a colored layer, wherein the glass contains one or more glass components selected from the group consisting of Sb ions, As ions, Sn ions, and Ce ions in an amount of 0.075 cation % or more.

### BACKGROUND OF THE INVENTION

The present invention relates to glass including a colored layer.

Glass including a colored glass portion can be used in various applications such as daily necessities, Buddhist altar fittings, decorations, jewelry goods, works of art, glass articles such as an exterior of a small electronic device, and optical elements such as a lens, cover glass, and encoder. In the glass, the colored portion is required to have a desired optical density (OD) and a shape of the colored portion is sharp.

International Publication WO 2020/230649 discloses glass including a colored layer. However, in the glass disclosed in International Publication WO 2020/230649, when increasing the OD of the colored layer, the thickness of the colored layer may increase and the shape of the colored layer is not sharp.

[Patent Literature 1] International Publication WO 2020/230649

### SUMMARY OF THE INVENTION

An object of the present invention is to provide glass which includes a colored layer and in which a desired OD can be accomplished in the colored layer even when the thickness of the colored layer is small.

The gist of the present invention is as follows.

(1) Glass including:

a colored layer,

wherein the glass contains one or more glass components selected from the group consisting of Sb ions, As ions, Sn ions, and Ce ions in an amount of 0.075 cation % or more.

(2) The glass according to (1),

wherein Bi ions are contained as the glass component.

(3) The glass according to (1) or (2),

wherein a refractive index is 1.70 or more.

(4) The glass according to any one of (1) to (3),

wherein a difference between a minimum value of a transmittance in a visible light region of the colored layer and a minimum value of a transmittance in a visible light region of a non-colored portion is 10% or more.

(5) A glass article including:

the glass according to any one of (1) to (4).

(6) An optical glass including:

the glass according to any one of (1) to (4).

(7) An optical element including:

the glass according to any one of (1) to (4).

According to the present invention, it is possible to provide glass which includes a colored layer and in which a desired OD can be accomplished in the colored layer even when the thickness of the colored layer is small.

### BRIEF DESCRIPTION OF THE DRAWINGS

FIG. 1-1 is a graph illustrating an external transmittance of a portion including a colored layer and a non-colored portion with respect to a glass sample having a composition I obtained in Example 1-1;

FIG. 1-2 is a graph illustrating an external transmittance of a portion including a colored layer and a non-colored portion with respect to a glass sample having a composition I obtained in Example 1-2;

FIG. 1-3 is a graph illustrating an external transmittance of a portion including a colored layer and a non-colored portion with respect to a glass sample having a composition I obtained in Example 1-3;

FIG. 1-4 is a graph illustrating an external transmittance of a portion including a colored layer and a non-colored portion with respect to a glass sample having a composition II obtained in Example 1-4;

FIG. 1-5 is a graph illustrating an external transmittance of a portion including a colored layer and a non-colored portion with respect to a glass sample having a composition II obtained in Example 1-5;

FIG. 2 is a graph illustrating a difference between an external transmittance obtained with respect to a glass sample before forming a colored layer and an external transmittance obtained with respect to a non-colored portion after forming the colored layer in a glass sample obtained in Example 2 when the amount of Sb ions is set to the horizontal axis;

FIG. 3-1 is a graph illustrating the thickness of a colored layer in a glass sample obtained in Example 3 when the amount of Sb ions is set to the horizontal axis;

FIG. 3-2 is a graph illustrating an OD in the glass sample obtained in Example 3 when the amount of Sb ions is set to the horizontal axis;

FIG. 4 is a graph illustrating a distance from an outer edge of an Ni paste film that is formed to an outer edge of a colored layer that is formed in a glass sample obtained in Example 4 when the amount of Sb ions is set to the horizontal axis;

FIG. 5 is a graph illustrating a difference in an outer transmittance obtained with respect to a non-colored portion after forming a colored layer in a glass sample obtained in Example 5 when the amount of ions is set to the horizontal axis;

FIG. 6 is a graph illustrating an OD in the glass sample obtained in Example 5 when the amount of ions is set to the horizontal axis;

FIG. 7 is a graph illustrating a distance from an outer edge of an Ni paste film that is formed to an outer edge of a colored layer that is formed in the glass sample obtained in Example 5 when the amount of ions is set to the horizontal axis; and

FIG. 8 is a graph illustrating the thickness of a colored layer in the glass sample obtained in Example 5 when the amount of ions is set to the horizontal axis.

### DETAILED DESCRIPTION OF THE PREFERRED EMBODIMENTS

In an embodiment, description will be given of glass according to the present invention on the basis of content ratios of respective components in notation of cation %. Accordingly, hereinafter, with regard to respective amounts, “%” represents “cation %” unless otherwise stated.

The notation of cation % represents a mole percentage when the total amount of all cation components is set to 100%. In addition, the total amount represents the total amount of a plurality of kinds of cation components (also including a case where the amount is 0%). In addition, a cation ratio represents a proportion (ratio) of the amount between cation components (also including the total amount of a plurality of kinds of cation components) in cation %.

The amount of a glass component is measured by a known method, for example, inductively coupled plasma atomic emission spectroscopic analysis (ICP-AES), inductively coupled plasma mass spectrometry (ICP-MS), or the like. In addition, in this specification and the present invention, when the amount of a constituent component is 0%, this represents that the constituent component is substantially not contained, and the component is allowed to be contained in an inevitable impurity level.

In addition, in this specification, a refractive index represents a refractive index nd at a d-line (wavelength: 587.56 nm) of yellow helium unless otherwise stated.

Hereinafter, an embodiment of the present invention will be described in detail.

Glass according to this embodiment includes a colored layer. The colored layer is a colored glass portion, and preferably exists in a layer shape from a glass surface toward the inside.

In the glass according to this embodiment, the colored layer may exist to cover the entirety of a glass surface (on the entirety of the glass surface), and may exist to cover a part of the glass surface (on a part of the glass surface).

The colored layer is a portion where a transmittance of light incident to the glass is small. Accordingly, in the glass according to this embodiment, in the light incident to the glass, a part or the entirety of the light incident to the colored layer is absorbed, and the intensity of transmitted light further attenuates in comparison to light that is not incident to the colored layer. That is, the glass according to this embodiment may have a portion with a small transmittance and a portion with a large transmittance.

In addition, in the glass according to this embodiment, the colored layer may be removed through grinding or polishing. In the glass according to this embodiment, the transmittance of the glass after removing the colored layer becomes larger than the transmittance before removing the colored layer.

The glass according to this embodiment contains one or more glass components selected from the group consisting of Sb ions, As ions, Sn ions, and Ce ions. The glass according to this embodiment preferably contains one or more glass components selected from the group consisting of Sb ions and As ions, and more preferably contains Sb ions.

In the glass according to this embodiment, a lower limit of the amount of the one or more glass components selected from the group consisting of Sb ions, As ions, Sn ions, and Ce ions is 0.075%, preferably 0.10%, and more preferably in the order of 0.125%, 0.15%, 0.175%, 0.20%, 0.22%, 0.24%, 0.26%, 0.28%, and 0.30%. In addition, an upper limit of the amount is preferably 1.00%, and more preferably in the order of 0.90%, 0.80%, 0.70%, 0.60%, and 0.50%. Note that, in a case where the glass contains two or more of the above glass components, the amount represents a total amount thereof. When the amount is set to the above-described range, even when the thickness of the colored layer is small, the transmittance can be reduced, that is, even when the thickness of the colored layer is small, an OD desired in the colored layer can be accomplished. In addition, when the amount is set to the above-described range, since the colored layer is darkly colored, and a portion (hereinafter, may be referred to as a non-colored portion) where the colored layer is not formed is less likely to be colored, sharpness of a shape of the colored layer can be improved. On the other hand, when the amount is excessively small, it is difficult to sufficiently reduce the transmittance while the thickness of the colored layer is kept small, and there is a concern that a desired OD may not be obtained. In addition, the non-colored portion is likely to be colored, and there is a concern that the sharpness of the shape of the colored layer is reduced. Furthermore, fine air bubbles are likely to remain in the entirety of the glass. When the amount is excessively large, platinum (Pt) derived from a melting furnace is likely to be eluted into the glass at the time of melting the glass, and thus there is a concern that the entirety of the glass is likely to be colored.

Note that, in this embodiment, the Sb ions include all Sb ions different in a valence, including Sb³⁺. The As ions include all As ions different in a valence, including As³⁺ and As⁵⁺. The Sn ions include all Sn ions different in a valence, including Sn⁴⁺. The Ce ions include all Ce ions different in a valence, including Ce⁴⁺.

In the glass according to this embodiment, a difference between a minimum value of the transmittance in a visible light region of the colored layer and a minimum value of the transmittance in a visible light region of the non-colored portion is preferably 10% or more, and more preferably in the order of 20% or more, 30% or more, 40% or more, 50% or more, 60% or more, and 70% or more. In addition, an upper limit of a difference between the minimum value of the transmittance in the visible light region of the colored layer and the minimum value of the transmittance in the visible light region of the non-colored portion is not particularly limited, and can be set to 80%. Here, the visible light region is a wavelength region of 440 to 780 nm.

When the difference between the minimum value of the transmittance in the visible light region of the colored layer and the minimum value of the transmittance in the visible light region of the non-colored portion is excessively small, there is a concern that sharpness of the shape of the colored layer may be reduced. In addition, there is a concern that it may be difficult to sufficiently reduce the transmittance while the thickness of the colored layer is kept small, and that a desired OD may not be obtained.

In the glass according to this embodiment, the non-colored portion may have a wavelength region where the transmittance is reduced in a wavelength of 380 to 780 nm. The wavelength region where the transmittance of the non-colored portion is reduced is not particularly limited, but the wavelength region is typically a range of 450 to 550 nm, and preferably a range of 450 to 520 nm.

The reason why the transmittance of the non-colored portion is reduced in the visible light region is not particularly limited, but the reason is considered as follows.

As to be described later, the glass is subjected to a heat treatment in a reducing atmosphere to form the colored layer. At this time, variation of a valence of a transition metal contained in the glass is promoted by a gas that is contained in the reducing atmosphere and has reducing power, for example, hydrogen. As a result, it is considered that the glass absorbs a specific wavelength due to the variation of the valence of the transition metal. At this time, in the non-colored portion, a slight reduction of the transmittance due to absorption of the specific wavelength can be detected by continuously measuring the transmittance in the visible light region. On the other hand, in the colored layer, since the transmittance decreases sufficiently over the entirety of the visible light region, a slight reduction of the transmittance in the specific wavelength is less likely to be detected.

In the glass according to this embodiment, the thickness of the colored layer is not particularly limited, but can be set to 1 to 150 μm. In addition, in a top view of the glass, a width of the colored layer is not particularly limited, but can be set to 1 to 100 μm. When the thickness and the width of the colored layer are set to the above-described ranges, sharpness of a shape of the colored layer can be improved.

### (OD)

In the glass according to this embodiment, a spectral transmittance of the colored layer in a wavelength region from a wavelength region of 380 to 780 nm to an infrared region tends to increase as the wavelength is lengthened. On the other hand, the OD of the colored layer tends to decrease as the wavelength is lengthened. “OD” is an optical density or an optical concentration, and is expressed by a numerical value obtained by adding a negative sign (minus) to a common logarithm of a ratio of an incident light intensity I₀ and a transmitted light intensity I as expressed by the following Expression.

OD=−log₁₀(I/I₀)

In a case where the glass according to this embodiment includes the colored layer and a non-colored portion in which a transmittance of a visible region is large, the OD of the colored layer is large, and the OD of the non-colored portion becomes small. In measurement of the OD, in a case where measurement light passes through both the colored layer and the non-colored portion, since the OD of the non-colored portion is sufficiently small, the OD of the colored layer becomes dominant.

In the glass according to this embodiment, the OD of a portion provided with the colored layer at a wavelength of 1100 nm is preferably 1.0 or more, and more preferably 1.5 or more. On the other hand, the OD of the non-colored portion at a wavelength of 1100 nm is preferably 0.15 or less, and more preferably 0.1 or less.

Typically, a sensitivity region of an optical sensor such as CCD and a C-MOS sensor ranges from a visible region to the vicinity of 1100 nm. When a colored layer having the OD in the above-described range is provided, glass capable of shielding light over the entirety of the sensitivity region of the optical sensor is obtained. Accordingly, it is preferable that the glass according to this embodiment can control a transmittance with respect to light beams in a wavelength region ranging from a visible region to 1100 nm.

Note that, in glass having two surfaces facing each other, the OD in a case where the colored layer is provided on both surfaces becomes two times a case where the same colored layer is provided on only one surface.

In addition, in the glass according to this embodiment, the OD decreases in combination with an increase of a wavelength in a wavelength region ranging from a visible region to a near-infrared region. Accordingly, in a portion provided with the colored layer, for example, the OD at a wavelength of 780 nm further increases than the OD at a wavelength of 1100 nm.

Accordingly, in a case where a wavelength region desired to be shielded, the OD is designed to be high enough at a wavelength on a long wavelength side in the wavelength region. In a case of designing glass that shields only visible light, the OD may be set to be high enough on a long wavelength side of a visible light region (for example, 780 nm). In addition, in a case of designing glass that shields from a visible region to a near-infrared region, the OD may be set to be high enough at a wavelength of the near-infrared region (for example, a wavelength of 1100 nm). The OD can be controlled by adjusting the thickness or the degree of coloration of the colored layer.

(Refractive Index) In the glass according to this embodiment, a refractive index nd is preferably 1.70 or more, and more preferably in the order of 1.73 or more, 1.75 or more, 1.76 or more, 1.77 or more, 1.78 or more, 1.79 or more, and 1.80 or more. An upper limit of the refractive index nd is not particularly limited, but is typically 2.5 or more, and preferably 2.3 or more.

In the glass according to this embodiment, a plurality of colored layers having a small thickness may be provided with a predetermined interval at portions where both surfaces of the glass face each other so that a portion where the colored layers are not provided functions as a slit. At this time, when the refractive index of the glass is set to the above-described range, even in a case where an incident angle of light beams incident to the slit portion is large (light beams are incident at a shallow angle), the light beams are absorbed to the colored layer formed on a rear surface of the glass and the light beams are not transmitted through an adjacent slit, and thus the same effect as in a case of providing the colored layer in the entirety of a thickness direction of the glass can be obtained, and an interval of the slits can be narrowed. On the other hand, when the refractive index of the glass is excessively low, in a case where the incident angle of the light beams incident to the slit portion is large, there is a concern that the light beams are transmitted to the adjacent slit, and the same effect as in a case of providing the colored layer in the entirety of the thickness direction of the glass may not be obtained.

### Glass Composition

In the glass according to this embodiment, a glass composition is the same between the colored layer and the non-colored portion. However, the valence of glass components (cations) may be difference between the colored layer and the non-colored portion.

Coloration of the colored layer is preferably a reduction color caused by a glass component, and more preferably a reduction color caused by a transition metal. Examples of the transition metal include Ti, Nb, W, and Bi. Particularly, from the viewpoint of accomplishing a desired OD even when the thickness of the colored layer is small, the glass according to this embodiment preferably contains Bi ions as the glass component, more preferably one or more selected from the group consisting of Ti ions, Nb ions, and W ions. In a case where the glass does not contain the glass component, there is a concern that it is difficult to reduce the transmittance while the thickness of the colored layer is set to be small, and the desired OD may not be obtained. In addition, there is a concern that sharpness of the shape of the colored layer is reduced.

With regard to the composition of the glass according to this embodiment, a non-limiting example will be described below.

The glass according to this embodiment is preferably phosphate glass. The phosphate glass represents glass that mainly contains P⁵⁺ as a glass network forming component. As the glass network forming component, P⁵⁺, B³⁺, Si⁴⁺, Al³⁺, and the like are known. Here, description of “phosphate is mainly contained as the glass network forming component” represents that the amount of P⁵⁺ is larger than the amount of any of B³⁺, Si⁴⁺, and Al³⁺. In a case where the glass is the phosphate glass, the degree of coloration in the colored layer can be raised.

In the glass according to this embodiment, a lower limit of the amount of P⁵⁺ is preferably 10%, and more preferably in the order of 13%, 15%, 17%, and 20%. In addition, an upper limit of the amount of P⁵⁺ is preferably 50%, and more preferably in the order of 45%, 40%, 38%, 35%, 33%, and 30%.

P⁵⁺ is a glass network forming component. On the other hand, when P⁵⁺ is excessively contained, meltability deteriorates. Therefore, the amount of P⁵⁺ is preferably within the above-described range.

In the glass according to this embodiment, an upper limit of the amount of B³⁺ is preferably 30%, and more preferably in the order of 25%, 20%, 15%, 13%, and 10%. In addition, a lower limit of the amount of B³⁺ is preferably 0.1%, and more preferably in the order of 0.5%, 1%, 3%, and 5%. The amount of B³⁺ may be 0%.

B³⁺ is a glass network forming component, and has an operation of improving meltability of the glass. On the other hand, when the amount of B³⁺ is excessively large, chemical durability of the glass tends to decrease. Therefore, the amount of B³⁺ is preferably within the above-described range.

In the glass according to this embodiment, an upper limit of a cation ratio of the amount of B³⁺ to the amount of P⁵⁺[B³⁺/P⁵⁺] is preferably 0.70, and more preferably in the order of 0.60, 0.55, and 0.50. The cation ratio [B³⁺/P⁵⁺] may be 0.

In the glass according to this embodiment, an upper limit of the amount of Si⁴⁺ is preferably 10%, and more preferably in the order of 7%, 5%, 3%, 2%, and 1%. In addition, a lower limit of the amount of Si⁴⁺ is preferably 0.1%, and more preferably in the order of 0.2%, 0.3%, 0.4%, and 0.5%. The amount of Si⁴⁺ may be 0%.

Si⁴⁺ is a glass network forming component, and has an operation of improving thermal stability, chemical durability, and weather resistance of the glass. On the other hand, when the amount of Si⁴⁺ is excessively large, there is a concern that meltability of the glass deteriorates, and a glass raw material tends to remain in a partially non-melted state. Therefore, the amount of Si⁴⁺ is preferably within the above-described range.

In the glass according to this embodiment, an upper limit of the amount of Al³⁺ is preferably 10%, and more preferably in the order of 7%, 5%, 3%, and 1%. The amount of Al³⁺ may be 0%.

Al³⁺ has an operation of improving chemical durability and weather resistance of the glass. On the other hand, when the amount of Al³⁺ is excessively large, thermal stability of the glass may deteriorate, a glass transition temperature Tg may be raised, and meltability is likely to deteriorate. Therefore, the amount of Al³⁺ is preferably within the above-described range.

In the glass according to this embodiment, a lower limit of the total amount of P⁵⁺, B³⁺, Si⁴⁺, and A³⁺[P⁵⁺+B³⁺+Si⁴⁺+Al³⁺] is preferably 10%, and more preferably in the order of 15%, 18%, 20%, 23%, and 25%. In addition, an upper limit of the total amount [P⁵⁺+B³⁺+Si⁴⁺+Al³⁺] is preferably 60%, and more preferably in the order of 50%, 45%, 40%, 37%, and 35%.

In the glass according to this embodiment, a lower limit of the amount of the Bi ions is preferably 0.5%, and more preferably in the order of 1%, 2%, and 2.5%. In addition, an upper limit of the amount of the Bi ions is preferably 40%, and more preferably in the order of 35%, 30%, 28%, and 25%. The Bi ions include all Bi ions different in a valence, including Bi³⁺.

The Bi ions have an operation of contributing to a high refractive index, and incrementing coloration of the glass. Accordingly, the amount of the Bi ions is preferably within the above-described range.

In the glass according to this embodiment, a lower limit of the amount of the Ti ions is preferably 1%, and more preferably in the order of 2% and 3%. In addition, an upper limit of the amount of the Ti ions is preferably 45%, and more preferably in the order of 40%, 35%, 30%, 25%, 20%, 15%, and 12%. Here, the Ti ions include all Ti ions different in a valence, including Ti⁴⁺ and Ti³⁺.

The Ti ions have an operation of greatly contributing to a high refractive index and incrementing coloration of the glass as in the Nb ions, the W ions, and the Bi ions. On the other hand, when the amount of the Ti ions is excessively large, meltability of the glass may deteriorate, and a glass raw material tends to remain in a partially non-melted state. Therefore, the amount of the Ti ions is preferably within the above-described range.

In the glass according to this embodiment, a lower limit of the amount of the Nb ions is preferably 1%, and more preferably in the order of 5%, 10%, and 15%. In addition, an upper limit of the amount of the Nb ions is preferably 45%, and more preferably in the order of 40%, 35%, 30%, 25%, 23%, and 20%. The Nb ions include all Nb ions different in a valence, including Nb⁺⁵.

The Nb ions have an operation of contributing to a high refractive index, and incrementing coloration of the glass. In addition, the Nb ions have an operation of improving thermal stability and chemical durability of the glass. On the other hand, when the amount of the Nb ions is excessively large, the thermal stability of the glass tends to deteriorate. Therefore, the amount of the Nb ions is preferably within the above-described range.

In the glass according to this embodiment, an upper limit of the amount of the W ions is preferably 30%, and more preferably in the order of 25%, 20%, 15%, and 13%. In addition, a lower limit of the amount of the W ions is preferably 0.5%, and more preferably in the order of 1%, 2%, and 3%. The W ions include all W ions different in a valence, including W⁶⁺.

The W ions have an operation of contributing to a high refractive index, and incrementing coloration of the glass. Accordingly, the amount of the W ions is preferably within the above-described range.

In the glass according to this embodiment, a lower limit of the total amount of the Ti ions, the Nb ions, and the W ions [Ti+Nb+W] is preferably 1%, and more preferably in the order of 5%, 10%, 15%, 20%, and 23%. In addition, an upper limit of the total amount [Ti+Nb+W] is preferably 60%, and more preferably in the order of 55%, 50%, 45%, 40%, 38%, and 35%.

In the glass according to this embodiment, an upper limit of the total amount of the Ti ions, the Nb ions, the W ions, and the Bi ions [Ti+Nb+W+Bi] is preferably 80%, and more preferably in the order of 75%, 70%, 68%, and 65%. In addition, a lower limit of the total amount [Ti+Nb+W+Bi] is preferably 1%, and more preferably in the order of 5%, 10%, 15%, 20%, 23%, and 25%.

In the glass according to this embodiment, a lower limit of a cation ratio of the total amount of the Ti ions, the Nb ions, the W ions, and the Bi ions to the total amount of P⁵⁺, B³⁺, and Si⁴⁺[(Ti+Nb+W+Bi)/(P⁵⁺+B³⁺+Si⁴⁺)] is preferably 0.1, and more preferably in the order of 0.3, 0.5, 0.6, and 0.7. In addition, an upper limit of the cation ratio [(Ti+Nb+W+Bi)/(P⁵⁺+B³⁺+Si⁴⁺)] is preferably 4.0, and more preferably in the order of 3.5, 3.0, 2.7, and 2.5.

In the glass according to this embodiment, a lower limit of a ratio of a value obtained by dividing the total amount of the Ti ions, the Nb ions, the W ions, and the Bi ions by the amount of the Sb ions to the total amount of P⁵⁺, B³⁺, and Si⁴⁺ [{(Ti+Nb+W+Bi)/Sb}/(P⁵⁺+B³⁺+Si⁴⁺)] is preferably 0.3, and more preferably in the order of 1.0, 1.5, and 2.0. In addition, an upper limit of the ratio [{(Ti+Nb+W+Bi)/Sb}/(P⁵⁺+B³⁺+Si⁴⁺)] is preferably 33, and more preferably in the order of 20, 12, 9, 6, 5, 4.0, 3.5, 3.0, and 2.5. When the ratio [{(Ti+Nb+W+Bi)/Sb}/(P⁵⁺+B³⁺+Si⁴⁺)] is set to the above-described range, glass capable of accomplishing a desired OD is obtained even when the thickness of the colored layer is small.

In the glass according to this embodiment, an upper limit of the amount of Ta⁵⁺ is preferably 5%, and more preferably in the order of 3%, 2%, and 1%. The amount of Ta⁵⁺ may be 0%.

Ta⁵⁺ has an operation of improving thermal stability of the glass. On the other hand, when the amount of Ta⁵⁺ is excessively large, there is a tendency that the glass has a low refractive index and meltability deteriorates. Therefore, the amount of Ta⁵⁺ is preferably within the above-described range.

In the glass according to this embodiment, an upper limit of the amount of Li⁺ is preferably 35%, and more preferably in the order of 30%, 27%, 25%, 23%, and 20%. In addition, a lower limit of the amount of Li⁺ is preferably 1%, and more preferably in the order of 2%, 3%, 5%, and 8%. The amount of Li⁺ may be 0%.

In the glass according to this embodiment, an upper limit of the amount of Na⁺ is preferably 40%, and more preferably in the order of 35%, 30%, 25%, 20%, and 18%. In addition, a lower limit of the amount of Na⁺ is preferably 0.5%, and more preferably in the order of 1%, 1.5%, 3%, and 5%. The amount of Na⁺ may be 0%.

When the glass contains Li⁺ or Na⁺, it is easy to carry out chemical reinforcement on the glass. On the other hand, when the amount of Li⁺ or Na⁺ is excessively large, there is a concern that thermal stability of the glass may deteriorate. Therefore, the amount of each of Li⁺ and Na⁺ is preferably within the above-described range.

In the glass according to this embodiment, an upper limit of the total amount of Li⁺ and Na⁺[Li⁺+Na⁺] is preferably 45%, and more preferably in the order of 43%, 40%, and 38%. In addition, a lower limit of the total amount [Li⁺+Na⁺] is preferably 1%, and more preferably in the order of 5%, 10%, 15%, and 20%.

In the glass according to this embodiment, an upper limit of the amount of K⁺ is preferably 20%, and more preferably in the order of 15%, 13%, 10%, 8%, 5%, and 3%. In addition, a lower limit of the amount of K⁺ is preferably 0.1%, and more preferably in the order of 0.5%, 1.0%, and 1.2%. The amount of K⁺ may be 0%.

K⁺ has an operation of improving thermal stability of the glass. On the other hand, when the amount of K⁺ is excessively large, the thermal stability tends to deteriorate. Therefore, the amount of K⁺ is preferably within the above-described range.

In the glass according to this embodiment, an upper limit of the amount of Rb⁺ is preferably 5%, and more preferably in the order of 3%, 1%, and 0.5%. The amount of Rb⁺ may be 0%.

In the glass according to this embodiment, an upper limit of the amount of Cs⁺ is preferably 5%, and more preferably in the order of 3%, 1%, and 0.5%. The amount of Cs⁺ may be 0%.

Rb⁺ and Cs⁺ have an operation of improving meltability of the glass. On the other hand, when the amount thereof is excessively large, there is a concern that the refractive index nd is lowered, and volatilization of glass components increases during melting. Therefore, the amount of each of Rb⁺ and Cs⁺ is preferably within the above-described range.

In the glass according to this embodiment, an upper limit of the amount of Mg²⁺ is preferably 15%, and more preferably in the order of 10%, 5%, 3%, and 1%. The amount of Mg²⁺ may be 0%.

In the glass according to this embodiment, an upper limit of the amount of Ca²⁺ is preferably 15%, and more preferably in the order of 10%, 5%, 3%, and 1%. The amount of Ca²⁺ may be 0%.

In the glass according to this embodiment, an upper limit of the amount of Sr²⁺ is preferably 15%, and more preferably in the order of 10%, 5%, 3%, and 1%. The amount of Sr²⁺ may be 0%.

In the glass according to this embodiment, an upper limit of the amount of Ba²⁺ is preferably 25%, and more preferably in the order of 20%, 18%, 15%, 10%, and 5%. The amount of Ba²⁺ may be 0%.

Any of Mg²⁺, Ca²⁺, Sr²⁺, and Ba²⁺ has an operation of improving thermal stability and meltability of the glass. On the other hand, when the amount thereof is excessively large, there is a concern that a high refractive index property may be damaged, and thermal stability of the glass may deteriorate. Therefore, each amount of these glass components is preferably within the above-described range.

In the glass according to this embodiment, an upper limit of the total amount of Mg²⁺, Ca²⁺, Sr²⁺, and Ba²⁺[Mg²⁺+Ca²⁺+Sr²⁺+B²⁺] is preferably 30%, and more preferably in the order of 25%, 20%, 18%, 15%, 10%, and 5%.

In the glass according to this embodiment, an upper limit of the amount of Zn²⁺ is preferably 15%, and more preferably in the order of 10%, 8%, 5%, 3%, and 1%. In addition, a lower limit of the amount of Zn²⁺ is preferably 0.1%, and more preferably in the order of 0.3% and 0.5%. The amount of Zn²⁺ may be 0%.

Zn²⁺ has an operation of improving thermal stability of the glass. On the other hand, when the amount of Zn²⁺ is excessively large, there is a concern that meltability may deteriorate. Therefore, the amount of Zn²⁺ is preferably within the above-described range.

In the glass according to this embodiment, an upper limit of the amount of Zr⁴⁺ is preferably 5%, and more preferably in the order of 3%, 2%, and 1%. The amount of Zr⁴⁺ may be 0%.

Zr⁴⁺ has an operation of improving thermal stability of the glass. On the other hand, the amount of Zr⁴⁺ is excessively large, thermal stability and meltability of the glass tend to decrease. Therefore, the amount of Zr⁴⁺ is preferably within the above-described range.

In the glass according to this embodiment, an upper limit of the amount of Ga³⁺ is preferably 3%, and more preferably in the order of 2% and 1%. In addition, the lower limit of the amount of Ga³⁺ is preferably 0%. The amount of Ga³⁺ may be 0%.

In the glass according to this embodiment, an upper limit of the amount of In³⁺ is preferably 3%, and more preferably in the order of 2% and 1%. In addition, a lower limit of the amount of In³⁺ is preferably 0%. The amount of In³⁺ may be 0%.

In the glass according to this embodiment, an upper limit of the amount of Sc³⁺ is preferably 3%, and more preferably in the order of 2% and 1%. In addition, a lower limit of the amount of Sc³⁺ is preferably 0%. The amount of Sc³⁺ may be 0%.

In the glass according to this embodiment, an upper limit of the amount of Hf⁴⁺ is preferably 3%, and more preferably in the order of 2% and 1%. In addition, a lower limit of the amount of Hf⁴⁺ is preferably 0%. The amount of Hf⁴⁺ may be 0%.

In the glass according to this embodiment, an upper limit of the amount of Lu³⁺ is preferably 3%, and more preferably in the order of 2% and 1%. In addition, a lower limit of the amount of Lu³⁺ is preferably 0%. The amount of Lu³⁺ may be 0%.

In the glass according to this embodiment, an upper limit of the amount of Ge⁴⁺ is preferably 3%, and more preferably in the order of 2% and 1%. In addition, a lower limit of the amount of Ge⁴⁺ is preferably 0%. The amount of Ge⁴⁺ may be 0%.

In the glass according to this embodiment, an upper limit of the amount of La³⁺ is preferably 5%, and more preferably in the order of 4% and 3%. In addition, a lower limit of the amount of La³⁺ is preferably 0%. The amount of La³⁺ may be 0%.

In the glass according to this embodiment, an upper limit of the amount of Gd³⁺ is preferably 5%, and more preferably in the order of 4% and 3%. In addition, a lower limit of the amount of Gd³⁺ is preferably 0%. The amount of Gd³⁺ may be 0%.

In the glass according to this embodiment, an upper limit of the amount of Y³⁺ is preferably 5%, and more preferably in the order of 4% and 3%. In addition, a lower limit of the amount of Y³⁺ is preferably 0%. The amount of Y³⁺ may be 0%.

In the glass according to this embodiment, an upper limit of the amount of Yb³⁺ is preferably 3%, and more preferably in the order of 2% and 1%. In addition, a lower limit of the amount of Yb³⁺ is preferably 0%. The amount of Yb³⁺ may be 0%.

It is preferable that the cation components of the glass according to this embodiment mainly include the above-described components, that is, Sb ions, As ions, Sn ions, Ce ions, P⁵⁺, B³⁺, Si⁴⁺, Al³⁺, Ti ions, Nb ions, W ions, Bi ions, Ta⁵⁺, Li⁺, Na⁺, K⁺, Rb⁺, Cs⁺, Mg²⁺, Ca²⁺, Sr²⁺, Ba²⁺, Zn²⁺, Zr⁴⁺, Ga³⁺, In³⁺, Sc³⁺, Hf⁴⁺, Lu³⁺, Ge⁴⁺, La³⁺, Gd³⁺, Y³⁺, and Yb³⁺, and the total amount of the above-described components is preferably more than 95%, more preferably more than 98%, still more preferably more than 99%, and still more preferably more than 99.5%.

The glass according to this embodiment contains O²⁻ as an anion component, and may further contain F⁻. The amount of O²⁻ is preferably 90 anion % or more, more preferably 95 anion % or more, still more preferably 98 anion % or more, and still more preferably 99 anion % or more. The amount of O²⁻ may be 100 anion %. The amount of F⁻ is preferably 10 anion % or less, more preferably 5 anion % or less, still more preferably 2 anion % or less, and still more preferably 1 anion % or less. The amount of F⁻ may be 0 anion %. In addition, the glass may contain a component other than O²⁻ and F⁻. Examples of the anion component other than O²⁻ and F⁻ include Cl⁻, Br⁻, and I⁻. However, any of Cl⁻, Br⁻, and I⁻ is likely to volatile during melting of the glass. Due to volatilization of these components, a problem such as a fluctuation of glass properties, a decrease of homogeneity of the glass, and significant consumption of a melting facility occurs. Therefore, the amount of Cl⁻ is preferably less than 5 anion %, more preferably less than 3 anion %, still more preferably less than 1 anion %, still more preferably less than 0.5 anion %, and still more preferably less than 0.25 anion %. In addition, the total amount of Br⁻ and I⁻ is preferably less than 5 anion %, more preferably less than 3 anion %, still more preferably less than 1 anion %, still more preferably less than 0.5 anion %, still more preferably less than 0.1 anion %, and still more preferably 0 anion %.

Note that, the anion % represents a mole percentage when the sum of the amounts of all anion components is set to 100%.

It is preferable that the glass according to this embodiment is basically composed of the above-described components, but the glass may contain other components within a range not deteriorating the operation and the effect of the present invention.

For example, the glass according to this embodiment may further contain an appropriate amount of copper (Cu) as the glass component in order to impart near-infrared light absorption properties to the glass. In addition to this, the glass may contain V, Cr, Mn, Fe, Co, Ni, Pr, Nd, Pm, Sm, Eu, Tb, Dy, Ho, Er, Tm, Ce, or the like. These components may increment coloration of the glass, and may become a fluorescence generation source.

In addition, in the present invention, inevitable impurities may be contained.

### <Other Component Compositions>

Any of Pb, Cd, Tl, Be, and Se has toxicity. Therefore, it is preferable that the glass of this embodiment does not contain these elements as a glass component.

Any of U, Th, and Ra is a radioactive element. Therefore, it is preferable that the glass of this embodiment does not contain these elements as a glass component.

### Manufacture of Glass

The glass according to this embodiment is obtained by preparing non-colored glass and forming the colored layer in the non-colored glass. The non-colored glass may be prepared by a known glass manufacturing method. For example, a plurality of kinds of compounds are combined and are sufficiently mixed to obtain a batch raw material, and the batch raw material is put into a melting vessel to melt, clarify, and homogenize the batch raw material. Then, molten glass is molded and slowly cooled to obtain glass. Alternatively, the batch raw material is put into the melting vessel and roughly melted. A melted product obtained through the rough melting is quickly cooled and pulverized to prepare a cullet. In addition, the cullet is put into the melting vessel, and the cullet is heated and remelted to obtain molten glass. The molten glass is molded after clarification and homogenization, and is slowly cooled to obtain the glass. In the molding and slow cooling of the molten glass, a known method is applicable.

Furthermore, a process of raising the amount of moisture in the molten glass may be included in the process of manufacturing the glass according to this embodiment. Examples of the process of raising the amount of moisture in the molten glass include a process of adding a water vapor to a melting atmosphere, and a process of bubbling a gas containing a water vapor in a melted product. In the processes, the process of adding the water vapor to the melting atmosphere is preferably included. When the process of raising the amount of moisture in the molten glass is included, a βOH value of the glass can be raised. When the βOH value is raised, glass in which a non-colored portion has high transparency is obtained.

### Formation of Colored Layer

The colored layer can be formed by forming a metal film on a glass surface and performing a heat treatment in a reducing atmosphere.

As a metal that constitutes the metal film, a metal having an operation of storing hydrogen ions in an atmosphere, and reducing a glass component contained in the glass by giving and receiving hydrogen ions and electrons is preferable. A metal having an operation of reducing a transition metal among the glass components is more preferable. Specific examples of the metal include Ni, Au, Ag, Pt, Pd, a Pt—Pd alloy, and the like.

The method of forming the metal film on the glass surface is not particularly limited as long as the metal film can adhere to the glass surface in a close contact manner, and examples thereof include vapor deposition, sputtering, plating, application of a metal paste or a plating solution, and the like. In a case of forming a metal film having a fine shape, a photolithography technology, and a film formation technology of Pd or Pt—Pd may be combined.

The reducing atmosphere may contain a gas having reducing power. Examples of the gas having reducing power include a hydrogen. Accordingly, a hydrogen-containing gas is preferably used as the reducing atmosphere, and a hydrogen-containing forming gas may be used. The forming gas is a mixed gas composed of hydrogen and nitrogen, and typically contains approximately 3 to 5 volume % of hydrogen.

In the heat treatment, heating is performed at a temperature equal to or higher than a temperature lower than a glass transition temperature (Tg) by 200° C. (Tg-200), and is equal to or lower than a softening point temperature. A heat treatment time can be appropriately adjusted depending on the degree of coloration, a range of the colored layer, and the thickness of the colored layer which are desired, and the like.

After the heat treatment, the metal film is removed from the glass surface. A removal method is not particularly limited, but examples thereof include a removal method through polishing or dissolving.

Due to the heat treatment in the reducing atmosphere, the colored layer is formed from the glass surface with which the metal film comes into contact to an inner side of the glass.

A mechanism in which the colored layer is formed by the above-mentioned method is not particularly limited, but the mechanism is considered as follows.

Coloration of the colored layer formed in this embodiment is considered as a reduction color caused by the glass component, and particularly, a reduction color caused by the transition metal. Typically, even when a glass molded body is subjected to a heat treatment in an atmosphere containing hydrogen in a low concentration of approximately 3 to 5 volume %, the glass hardly exhibits the reduction color. However, since the metal film stores hydrogen ions in the atmosphere, a glass portion that is in contact with the metal film is supplied with a large amount of hydrogen ions in comparison to a portion that is not in contact with the metal film, and as a result, a reducing reaction proceeds fast. Accordingly, the glass portion that is in contact with the metal film is darkly colored. The amount of hydrogen ions stored due to the metal film is large, and the concentration of hydrogen in the atmosphere may decrease due to storage by the metal film. As such, the reducing reaction is less likely to proceed in the glass portion that is not in contact with the metal film.

Here, the reducing reaction of the glass component which causes coloration proceeds in all directions from a portion that is in contact with the metal film. That is, when being observed from a cross-section of the glass, the colored layer is formed from the glass surface that is in contact with the metal film in a thickness direction, and when being observed from the glass surface, the colored layer is formed radially from a portion that is in contact with the metal film.

In this embodiment, since the glass contains one or more glass components selected from the group consisting of Sb ions, As ions, Sn ions, and Ce ions in a predetermined amount or more, a colored layer that is more darkly colored can be formed by the above-described method. That is, in this embodiment, even when the thickness of the colored layer is small, a transmittance can be sufficiently reduced. In a case where the thickness of the colored layer is small, a range of the colored layer formed radially from the portion that is in contact with the metal film when being observed from the glass surface decreases. That is, according to this embodiment, when adjusting formation conditions of the colored layer, a colored layer having approximately the same shape as in the metal film can be formed when being observed from the glass surface.

### (Manufacture of Optical Element or the Like)

The glass according to this embodiment can be used as optical glass as is. The optical element according to this embodiment is obtained by preparing a non-colored optical element and forming the colored layer in the non-colored optical element. The non-colored optical element may be prepared in accordance with a known manufacturing method. For example, molten glass is cast into a mold, and is molded in a plate shape, thereby preparing a glass raw material. The obtained glass material is appropriately cut, grinded, and polished to prepare a cut piece having a size and a shape suitable for press molding. The cut piece is heated, softened, and press molded (reheat pressed) by a known method, thereby preparing an optical element blank that approximates a shape of the optical element. The optical element blank is annealed, and is grinded and polished by a known method, thereby preparing the optical element.

The colored layer can be formed in the prepared optical element by the above-described method. The colored layer may also be formed during the manufacturing process of the optical element.

An optical functional surface of the prepared optical element may be coated with an antireflection film, a total reflection film, or the like in correspondence with the purpose of use.

### Utilization

According to an aspect of the present invention, an optical element including the above-described glass can be provided. Examples of the kind of the optical element include lenses such as a spherical lens and aspherical lens, prisms, and the like. Examples of the shape of the lenses include various shapes such as a biconvex lens, a plano-convex lens, a biconcave lens, a plano-concave lens, a convex meniscus lens, a concave meniscus lens, and a rod lens. The optical element can be manufactured by a method including a process of processing a glass molded body molded from the above-mentioned glass. Examples of the processing include severing, cutting, rough grinding, fine grinding, polishing, and the like.

As an example of the optical element, an optical element configured to shield light obliquely incident to a light-receiving surface of an image sensor such as a CCD and a C-MOS sensor. In the related art, in order to shield light that is obliquely incident to the light-receiving surface of the image sensor, a method of applying a black ink to a portion of a cover glass surface of the image sensor which is desired to shield the oblique incident light so as to provide a light-shielding property has been used. In the method, there is a problem that light is reflected from a surface of the black ink at a boundary between a portion where the black ink is applied and a portion where the black ink is not applied, and becomes stray light, and thus an image quality of the image sensor deteriorates. In addition, degassing occurs in the ink when a temperature rises, and becomes the cause for hazing of a cover glass surface. In contrast, when the glass of this embodiment is used, and the colored layer is provided at a site desired to shield oblique incident light to provide cover glass, the problem of stray light or the problem of hazing due to degassing can be solved.

At the time of forming the colored layer, when being observed from a glass surface, the colored layer is formed to broaden radially from a glass portion that is in contact with the metal film toward an inner side. That is, the colored layer is formed to broaden not only in a thickness direction of the glass and but also in a direction parallel to the glass surface. The OD per unit thickness in the colored layer is large at a glass portion that is in contact with the metal film, that is, at the glass surface and a surface portion close to the surface, and tends to decrease as a distance from the glass surface increases. In addition, at a boundary between the colored layer and the non-colored portion, the OD decreases continuously and step by step from the colored layer toward the non-colored portion. In this manner, at the boundary between the colored layer and the non-colored portion, to be precise, the OD varies continuously and step by step. However, in this embodiment, a region where the OD varies continuously and step by step at the boundary between the colored layer and the non-colored portion is extremely limited, and it is not easy to visually recognize existence thereof. Since a wavelength of light incident to the glass is sufficiently smaller than the region where the OD varies continuously and step by step at the boundary between the colored layer and the non-colored portion, light incident to the region is absorbed and attenuated. Accordingly, for example, even when light incident to the non-colored portion is diffracted and propagates to the boundary between the colored layer and the non-colored portion, the light is attenuated at the boundary between the colored layer and the non-colored portion, and is less likely to be transmitted through the glass.

Description has been mainly given of application to the cover glass, but there is no limitation to the cover glass, and the glass according to this embodiment can also have a function as a window of the optical sensor or the like due to the shape of the colored layer. Other examples of the optical element include a lens provided with a colored layer on a side surface of a lens, a glass encoder with a colored layer having a precise shape on a glass surface, and a screen having a partial transmission property. Here, the glass encoder is a disk-shaped glass plate that can be used instead of rotary slit plate of an optical rotary encoder, and a site corresponding to a slit of the rotary slit plate can be set as a non-colored portion and a site corresponding to a shutter can be set as a colored layer. That is, in the glass encoder, a region where the OD varies continuously and step by step is provided at a boundary between the non-colored portion corresponding to the slit and the colored layer corresponding to the shutter. Accordingly, even when light incident to the glass encoder is diffracted and propagates to the boundary between the slit and the shutter, light is attenuated at the boundary. As a result, the diffracted light is suppressed from being incident to an optical sensor of the optical rotary encoder, and an erroneous operation of the encoder can be prevented. Note that, the effect obtained due to attenuation of light at the boundary between the colored layer and the non-colored portion as described above is obtained when the colored layer exists in a layer shape from the glass surface toward an inner side. Accordingly, the effect is also obtained in glass that contains Sb ions and is also obtained in glass that does not contain the Sb ions as long as the colored layer exists in a layer shape from the glass surface to an inner side.

In this embodiment, particularly, in a case of forming the glass encoder or the screen having a partial transmission property, and in a case of forming a plurality of lenses on a wafer, when forming the metal film at a desired site as described above, the colored layer can be collectively formed through a heat treatment in a reducing atmosphere, and a light shielding property can be provided in the desired site.

The glass according to this embodiment can be used as optical glass as is, but the present invention is not limited to the optical glass. According to an aspect of the present invention, since the shape of the colored layer can be sharply formed, it is possible to provide a glass article including the above-described glass by taking advantage of a decorative property of the colored layer. The glass article is not particularly limited, and examples thereof include daily necessities such as a tableware and a stationary, Buddhist altar fittings, decorations, jewelry goods, works of art, an exterior of a small electronic device, and the like. The glass article according to this embodiment can have desired drawings, characters, designs, and patterns due to the colored layer. Here, in a case of the related art, when a film is formed on an article surface and a design of a desired shape or the like is made, problems such as peeling-off of the film on the article surface, and a change in a color of the film is likely to occur. On the other hand, in this embodiment, the colored layer exists in a layer shape from the glass surface toward an inner side. Accordingly, peeling-off of the colored layer does not occur, and the color of the colored layer is less likely to change. That is, according to this embodiment, it is possible to provide a glass article in which problems such as peeling-off of a design or the like and a change in the color do not occur.

### EXAMPLES

Hereinafter, the present invention will be described in more detail with reference to examples, but the present invention is not limited to the examples.

Glass samples having Glass Composition Ito Glass Composition IV as illustrated in Table 1 were prepared in the following procedure, and various evaluations were performed. Note that, in examples, in respective compositions, a glass composition other than Sb ions, Sn ions, and Ce ions was kept constant, in Composition I, a glass sample in which the amount of the Sb ions is different within a range of 0% to 1.0% was prepared, and in Composition II, a glass sample in which the amount of the Sb ions is different within a range of 0% to 0.37% was prepared. Furthermore, in Composition I, a glass sample in which the amount of the Ce ions is different within a range of 0% to 0.42% was prepared, and a glass sample in which the amount of the Sn ions is different within a range of 0% to 0.48% was prepared. In Composition III, a glass sample in which the amount of the Sb ions is different within a range of 0% to 0.5% was prepared, and in Composition IV, a glass sample in which the amount of the Sb ions is different within a range of 0% to 0.5% was prepared. As shown in Table 1, any one kind of the Sb ions, the Sn ions, and the Ce ions is contained in respective compositions.

TABLE 1

| | | Composi- | Composi- | Composi- | Composi- |
|---|---|---|---|---|---|
| | | tion I | tion II | tion III | tion IV |
| Glass | P⁵⁺ | 25.7 | 25.7 | 22.0 | 27.0 |
| Composition | Nb ions | 19.3 | 24.7 | 19.8 | 18.6 |
| (cation %) | Ti ions | 2.7 | 0 | 4.3 | 9.9 |
| | W ions | 2.7 | 0 | 0 | 11.3 |
| | Bi ions | 3.2 | 3.2 | 4.0 | 25.4 |
| | Ba²⁺ | 0.5 | 0.5 | 0 | 4.4 |
| | B³⁺ | 6.4 | 6.4 | 10.0 | 0 |
| | Zn²⁺ | 1.1 | 1.1 | 0 | 0 |
| | Li⁺ | 20.3 | 20.3 | 0 | 0 |
| | Na⁺ | 16 | 16 | 33.0 | 2.5 |
| | K⁺ | 2.1 | 2.1 | 7.0 | 1.0 |
| | Total | 100 | 100 | 100.0 | 100.0 |
| | Sb ions | 0-1.0 | 0-0.37 | 0-0.5 | 0-0.5 |
| | Ce ions | 0-0.42 | 0 | 0 | 0 |
| | Sn ions | 0-0.48 | 0 | 0 | 0 |
| Glass | nd | 1.82 | 1.82 | 1.8 | 2.1 |
| properties | νd | 24.1 | 24.4 | 23.9 | 17.0 |
| | Tg (° C.) | 454 | 459 | 488 | 561 |
| | Ts (° C.) | 506 | 512 | 540 | 596 |
| | Specific | 3.69 | 3.62 | 3.5 | 5.63 |
| | gravity | | | | |

### Production of Glass

Oxides, hydroxides, metaphosphates, carbonates, and nitrates corresponding to the constituent components of the glass were prepared as raw materials, the raw materials were weighed and combined so that a composition of obtained glass becomes each composition shown in Table 1, and the raw materials were sufficiently mixed. The obtained combination raw material (batch raw material) was put into a platinum crucible, and was heated at 1100° C. to 1450° C. for two to three hours to obtain molten glass. The molten glass was stirred to be homogenized. After being clarified, the molten glass was cast into a press mold that was preheated at an appropriate temperature. The cast glass was subjected to a heat treatment near a glass transition temperature Tg for approximately one hour, and was cooled to room temperature within a furnace. The glass was processed into a size having a length of 40 mm, a width of 10 mm, and a thickness of 1.0 mm, and two surfaces having dimensions of 40 mm×10 mm was precisely polished (optically polished) to obtain a glass sample.

### Confirmation of Glass Component Composition

With respect to the obtained glass sample, the amounts of respective glass components were measured by inductively coupled plasma atomic emission spectroscopic analysis (ICP-AES), and it was confirmed that the amounts satisfy respective compositions shown in Table 1. In addition, in any glass sample, 100 anion % of O²⁻ was contained as an anion component.

### Measurement of Optical Properties

With respect to the obtained glass samples, a refractive index nd, Abbe number νd, a glass transition temperature Tg, a sag temperature Ts, and a specific gravity were measured. Results are shown in Table 1. Note that, the refractive index nd, the Abbe number νd, the glass transition temperature Tg, the sag temperature Ts, and the specific gravity of the glass sample were approximately the same regardless of the amounts of the Sb ions, Ce ions, and Sn ions and were within numerical values indicated by significant figures shown in Table 1.

### (i) Refractive Index nd and Abbe Number νd

Refractive indices nd, ng, nF, and nC were measured by a refractive index measuring method conforming to JIS standard JIS B 7071-1, and the Abbe number νd was calculated on the basis of Expression (1).

νd=(nd−1)/(nF−nC) . . . (1)

### (ii) Glass Transition Temperature Tg and Sag Temperature Ts

The glass transition temperature Tg and the sag temperature Ts were measured at a temperature increase rate of 4° C./minute by using a thermomechanical analyzer (TMA4000S) manufactured by Mac Science Co. Ltd.

(iii) Specific Gravity

The specific gravity was measured by an Archimedes method.

### Example 1: Different in Transmittance

### Example 1-1

### Formation of Colored Layer

With respect to a sample in which the amount of the Sb ions is 0.10% among glass samples having Composition I, an Ni paste was applied to a part of one of optically polished surfaces, and was fired at a temperature lower than the glass transition temperature Tg by 50° C. (Tg-50° C.) for four hours, thereby forming an Ni paste film.

The glass sample on which the Ni paste film was formed was subjected to a heat treatment at 410° C. for 70 hours while feeding a forming gas (hydrogen: 3 volume % and nitrogen: 97 volume %) as a reducing atmosphere at a flow rate of 0.03 L/min.

The Ni paste film was peeled off by polishing. A colored layer was formed on a portion from which the Ni paste film was peeled off. A glass sample including the colored layer and a non-colored portion was obtained.

### Measurement of Transmittance

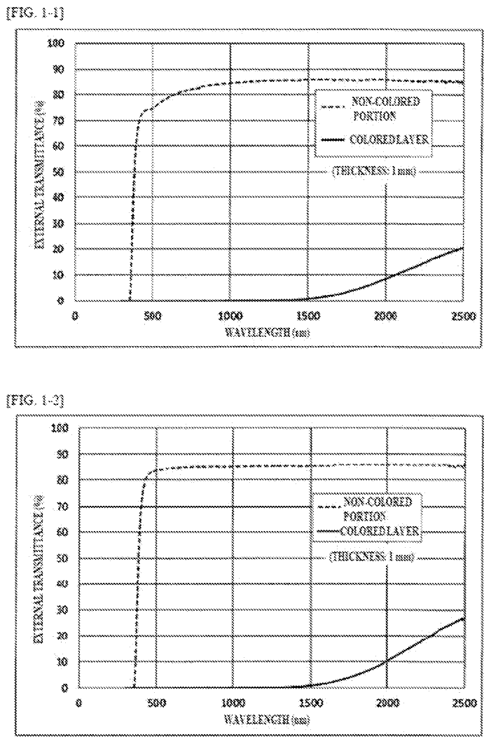

With respect to the portion provided with the colored layer and the non-colored portion, an external transmittance within a wavelength range of 300 to 2500 nm was measured. The external transmittance is defined as a percentage of transmitted light intensity to incident light intensity [transmitted light intensity/incident light intensity×100] when light is incident in a thickness direction of the glass sample. Note that, a reflection loss of light beams on a sample surface is also included in the external transmittance. Results are shown in FIG. 1-1.

### Example 1-2

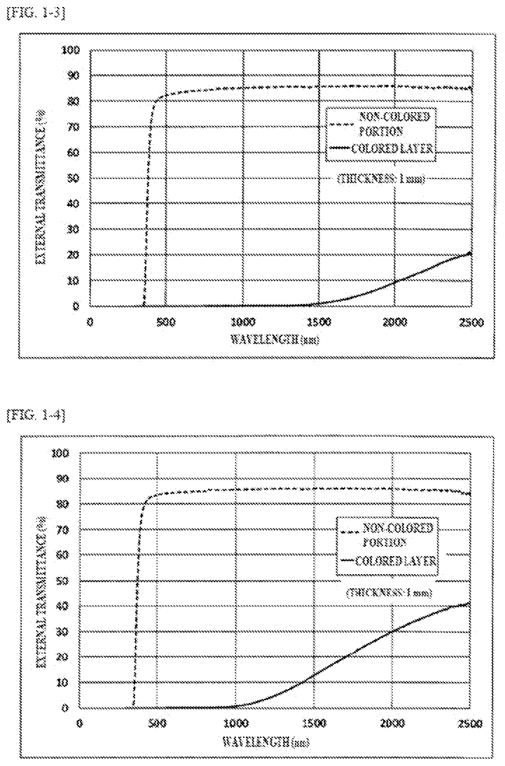

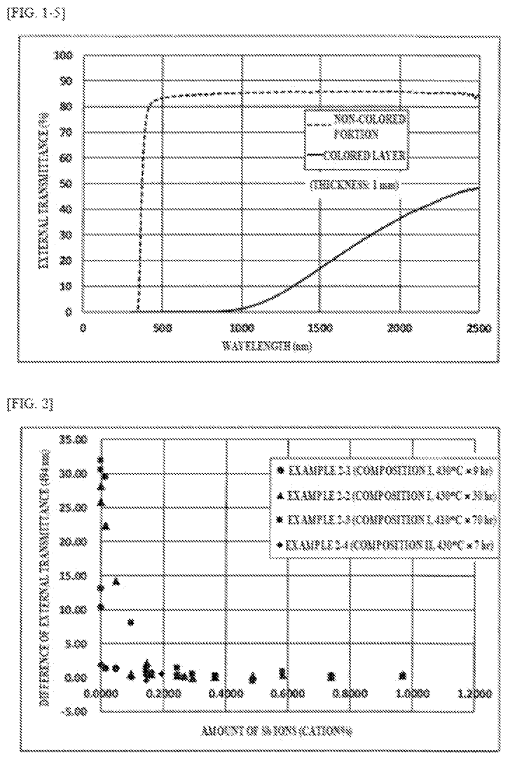

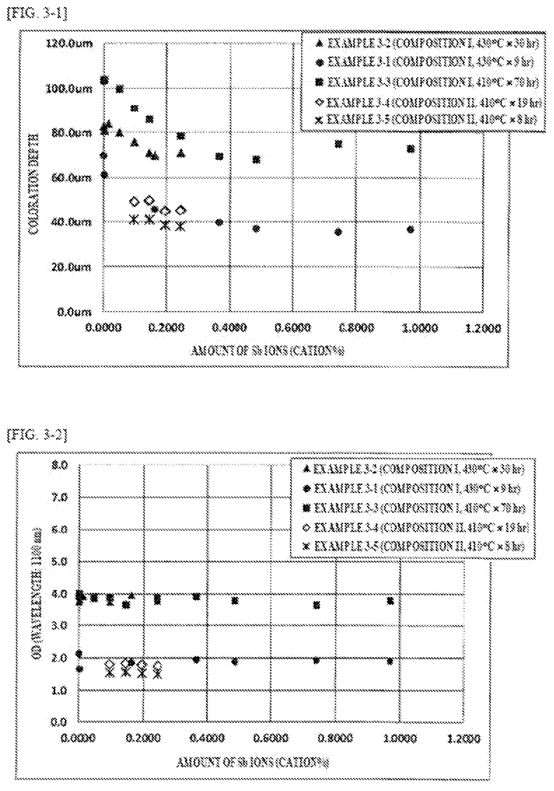

A colored layer was formed in a similar manner as in Example 1-1 except that a sample in which the amount of the Sb ions is 0.25% among glass samples having Composition I was used, and a heat treatment was performed at 430° C. for 30 hours, thereby obtaining a glass sample including the colored layer and a non-colored portion. The transmittance was measured in a similar manner as in Example 1-1. Results are shown in FIG. 1-2.

### Example 1-3

A colored layer was formed in a similar manner as in Example 1-1 except that a sample in which the amount of the Sb ions is 0.25% among glass samples having Composition I was used, and a heat treatment was performed at 410° C. for 70 hours, thereby obtaining a glass sample including the colored layer and a non-colored portion. The transmittance was measured in a similar manner as in Example 1-1. Results are shown in FIG. 1-3.

### Example 1-4

A colored layer was formed in a similar manner as in Example 1-1 except that a sample in which the amount of the Sb ions is 0.2% among glass samples having Composition II was used, and a heat treatment was performed at 410° C. for 19 hours, thereby obtaining a glass sample including the colored layer and a non-colored portion. The transmittance was measured in a similar manner as in Example 1-1. Results are shown in FIG. 1-4.

### Example 1-5

A colored layer was formed in a similar manner as in Example 1-1 except that a sample in which the amount of the Sb ions is 0.2% among glass samples having Composition II was used, and a heat treatment was performed at 430° C. for 8 hours, thereby obtaining a glass sample including the colored layer and a non-colored portion. The transmittance was measured in a similar manner as in Example 1-1. Results are shown in FIG. 1-5.

According to FIG. 1-1 to FIG. 1-5, in a glass sample in which the amount of the Sb ions is 0.075% or more, in any heat treatment condition, it was confirmed that a difference between a minimum value of a transmittance of the colored layer in a visible light region (a wavelength of 440 to 780 nm) and a minimum value of a transmittance of the non-colored portion in a visible light region is 10% or more.

### Example 2: Transparency of Non-Colored Portion

### Example 2-1

Glass samples including a colored layer and a non-colored portion were obtained in a similar manner as in Example 1-1 except that the heat treatment was performed on a plurality of glass samples that have Composition I and are different in the amount of the Sb ions at 430° C. for 9 hours at the time of forming the colored layer. Transparency of the non-colored portion as evaluated as follows. Results are shown in FIG. 2.

### Evaluation of Transparency of Non-Colored Portion

An external transmittance at a wavelength of 494 nm was measured with respect to a glass sample before forming the colored layer, and a non-colored portion after forming the colored layer. The external transmittance is defined as a percentage of transmitted light intensity to incident light intensity [transmitted light intensity/incident light intensity×100] when light is incident in a thickness direction of the glass sample. Note that, a reflection loss of light beams on a sample surface is also included in the external transmittance. A difference between the external transmittance obtained for the glass samples before forming the colored layer, and the external transmittance obtained for the non-colored portion after forming the colored layer was calculated.

### Example 2-2

Glass samples including a colored layer and a non-colored portion were obtained in a similar manner as in Example 2-1 except that the heat treatment was performed on a plurality of glass samples that have Composition I and are different in the amount of the Sb ions at 430° C. for 30 hours at the time of forming the colored layer. A difference between the external transmittance obtained for the glass samples before forming the colored layer, and the external transmittance obtained for the non-colored portion after forming the colored layer was calculated and the transparency of the non-colored portion was evaluated in a similar manner as in Example 2-1. Results are shown in FIG. 2.

### Example 2-3

Glass samples including a colored layer and a non-colored portion were obtained in a similar manner as in Example 2-1 except that the heat treatment was performed on a plurality of glass samples that have Composition I and are different in the amount of the Sb ions at 410° C. for 70 hours at the time of forming the colored layer. A difference between the external transmittance obtained for the glass samples before forming the colored layer, and the external transmittance obtained for the non-colored portion after forming the colored layer was calculated and the transparency of the non-colored portion was evaluated in a similar manner as in Example 2-1. Results are shown in FIG. 2.

### Example 2-4

Glass samples including a colored layer and a non-colored portion were obtained in a similar manner as in Example 2-1 except that the heat treatment was performed on a plurality of glass samples that have Composition II and are different in the amount of the Sb ions at 430° C. for 7 hours at the time of forming the colored layer. A difference between the external transmittance obtained for the glass samples before forming the colored layer, and the external transmittance obtained for the non-colored portion after forming the colored layer was calculated and the transparency of the non-colored portion was evaluated in a similar manner as in Example 2-1. Results are shown in FIG. 2.

According to FIG. 2, in glass samples in which the amount of the Sb ions is 0.075% or more, it was confirmed that the transmittance of the non-colored portion is approximately the same as the transmittance before forming the colored layer even in any heat treatment condition, and the transparency of the non-colored portion was secured. On the other hand, in glass sample in which the amount of the Sb ions is less than 0.075%, it was confirmed that the transmittance of the non-colored portion further decreased in comparison to the transmittance before forming the colored layer, and the transparency of the non-colored portion was damaged.

### Example 3: Thickness and OD of Colored Layer

### Example 3-1

Glass samples including a colored layer and a non-colored portion were obtained in a similar manner as in Example 1-1 except that the heat treatment was performed on a plurality of glass samples that have Composition I and are different in the amount of the Sb ions at 430° C. for 9 hours at the time of forming the colored layer. The thickness and the OD of the colored layer were measured as follows.

### Thickness of Colored Layer

Each of the glass samples was polished from an optically polished surface that is not provided with the colored layer to have a thickness of 0.60 mm. When observing a cross-section of a glass portion provided with the colored layer with a microscope, if the thickness of the glass is large, a problem that the thickness of the colored layer appears to be large is likely to occur. Here, the thickness of the glass was made small in order for the problem not to occur. A cross-section of a portion provided with the colored layer in the glass sample was observed with a microscope to measure the thickness of the colored layer. A magnification of the microscope was set to 500 times. Results are shown in FIG. 3-1.

### Measurement of OD

Incident light intensity I₀ and transmitted light intensity I at a wavelength of 1100 nm were measured with respect to a portion provided with the colored layer in the glass sample, and an optical density (OD) was calculated by the following Expression. Results are shown in FIG. 3-2.

OD=−log₁₀(I/I₀)

### Example 3-2

Glass samples including a colored layer and a non-colored portion were obtained in a similar manner as in Example 3-1 except that the heat treatment was performed on a plurality of glass samples that have Composition I and are different in the amount of the Sb ions at 430° C. and for 30 hours at the time of forming the colored layer. The thickness and the OD of the colored layer were measured in a similar manner as in Example 3-1.

### Example 3-3

Glass samples including a colored layer and a non-colored portion were obtained in a similar manner as in Example 3-1 except that the heat treatment was performed on a plurality of glass samples that have Composition I and are different in the amount of the Sb ions at 410° C. and for 70 hours at the time of forming the colored layer. The thickness and the OD of the colored layer were measured in a similar manner as in Example 3-1.

### Example 3-4

Glass samples including a colored layer and a non-colored portion were obtained in a similar manner as in Example 3-1 except that the heat treatment was performed on a plurality of glass samples that have Composition II and are different in the amount of the Sb ions at 410° C. and for 19 hours at the time of forming the colored layer. The thickness and the OD of the colored layer were measured in a similar manner as in Example 3-1.

### Example 3-5

Glass samples including a colored layer and a non-colored portion were obtained in a similar manner as in Example 3-1 except that the heat treatment was performed on a plurality of glass samples that have Composition II and are different in the amount of the Sb ions at 410° C. and for 8 hours at the time of forming the colored layer. The thickness and the OD of the colored layer were measured in a similar manner as in Example 3-1.

In Examples 3-1 to 3-5, the thickness of the colored layer was adjusted so that the OD becomes constant. Specifically, in Example 3-1, the thickness of the colored layer was increased or decreased so that the OD is within a range of 1.7 to 2.1 as illustrated in FIG. 3-2, and the results are shown in FIG. 3-1. Similarly, in Examples 3-2, 3-3, 3-4, and 3-5, the thickness of the colored layer was increased or decreased so that the OD is within a range of 3.7 to 4.0, a range of 3.7 to 4.0, a range of 1.7 to 1.8, and a range of 1.5 to 1.6, respectively, and the results are shown in FIG. 3-1. According to FIG. 3-1 and FIG. 3-2, in a glass sample in which the amount of the Sb ions is 0.075% or more, it was confirmed that a desired OD can be accomplished with a small thickness of the colored layer even in any heat treatment condition. On the other hand, in a glass sample in which the amount of the Sb ions is less than 0.075%, it was confirmed that it is necessary to make the thickness of the colored layer large so as to accomplish the desired OD, that is, the desired OD cannot be accomplished if the thickness of the colored layer is not made large.

### Example 4: Sharpness of Shape of Colored Layer

### Example 4-1

A colored layer was formed in a similar manner as in Example 1-1 except that with respect to a plurality of glass samples that have Composition I and are different in the amount of the Sb ions, an Ni paste film was formed in a size of 20 mm (vertical) and 10 mm (horizontal), a heat treatment was performed at 430° C. for 30 hours at the time of forming the colored layer, and the Ni paste film was not peeled off, thereby obtaining glass samples including the colored layer and a non-colored portion. At this time, the colored layer was formed to be slightly larger than the Ni paste film. Here, a distance from an outer edge of the formed Ni paste film to an outer edge of the formed colored layer was measured. Results are shown in FIG. 4.

### Example 4-2

Glass samples including a colored layer and a non-colored portion were obtained in a similar manner as in Example 4-1 except that the heat treatment was performed on a plurality of glass samples that have Composition I and are different in the amount of the Sb ions at 410° C. for 70 hours at the time of forming the colored layer. A distance from an outer edge of the formed Ni paste film to an outer edge of the formed colored layer was measured. Results are shown in FIG. 4.

### Example 4-3

Glass samples including a colored layer and a non-colored portion were obtained in a similar manner as in Example 4-1 except that the heat treatment was performed on a plurality of glass samples that have Composition II and are different in the amount of the Sb ions at 430° C. for 7 hours at the time of forming the colored layer. A distance from an outer edge of the formed Ni paste film to an outer edge of the formed colored layer was measured. Results are shown in FIG. 4.

According to FIG. 4, in a glass sample in which the amount of the Sb ions is 0.075% or more, the distance from the outer edge of the formed Ni paste film to the outer edge of the formed colored layer was reduced even in any heat treatment condition. That is, it was confirmed that the colored layer has approximately the same shape as in the formed Ni paste film, and sharpness of the shape of the colored layer was secured. On the other hand, in a glass sample in which the amount of the Sb ions is less than 0.075%, it was confirmed that the distance from the outer edge of the formed Ni paste film to the outer edge of the formed colored layer is larger in comparison to the glass sample in which the amount of the Sb ions is 0.075% or more, and the sharpness of the shape of the colored layer was damaged.

### Example 5

### Formation of Colored Layer

With respect to a plurality of glass samples that have Composition I and are different in the amount of Ce ions (hereinafter, referred to as “Composition I-ce”), a plurality of glass samples that have Composition I and are different in the amount of Sn ions (hereinafter, referred to as “Composition I-sn”), a plurality of glass samples that have Composition III and are different in the amount of Sb ions (hereinafter, referred to as “Composition III-sb”), and a plurality of glass samples that have Composition IV and are different in the amount of Sb ions (hereinafter, referred to as “Composition IV-sb”), an Ni paste was applied to a part of one of optically polished surfaces, and firing was performed at 410° C. for 4 hours, thereby forming an Ni paste film.

The glass sample (Composition I-sn) on which the Ni paste film was formed was subjected to a heat treatment at 430° C. for 5 hours while feeding a forming gas (hydrogen: 3 volume % and nitrogen: 97 volume %) as a reducing atmosphere at a flow rate of 0.03 L/min. The same treatment as described above was carried out except that the treatment temperature was set to 430° C. and the treatment time was set to 30 hours with respect to the glass sample (Composition I-ce), the treatment temperature was set to 464° C. and the treatment time was set to 30 hours with respect to the glass sample (Composition III-sb), and the treatment temperature was set to 537° C. with respect to the glass sample (Composition IV-sb).

The Ni paste film was peeled off from each of the glass samples through polishing. The colored layer was formed in a portion from which the Ni paste film was peeled off Glass samples including the colored layer and a non-colored portion were obtained.

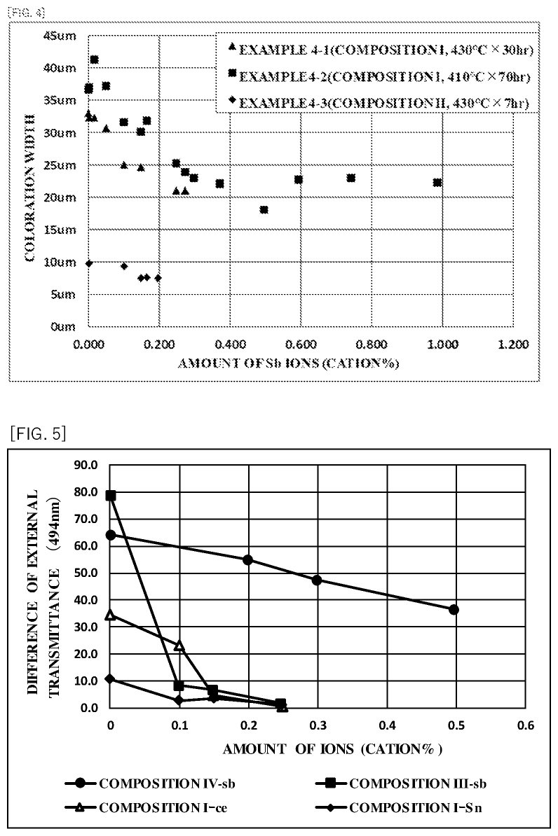

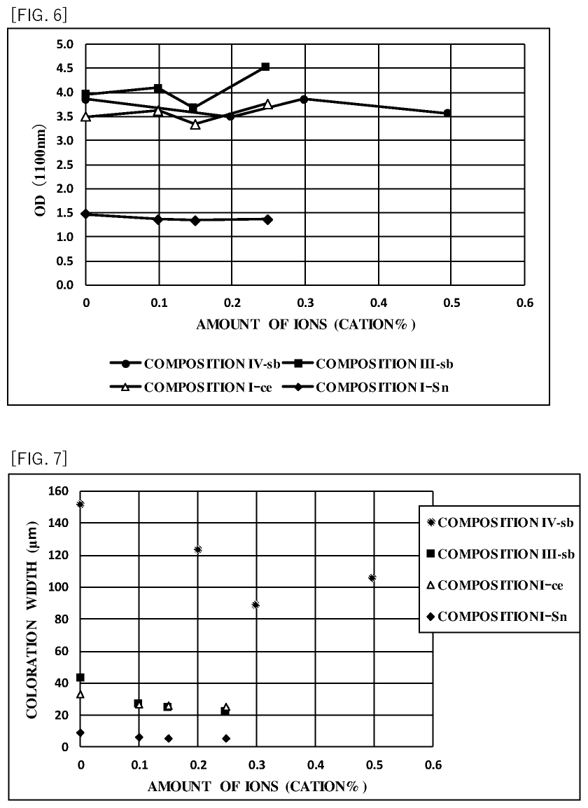

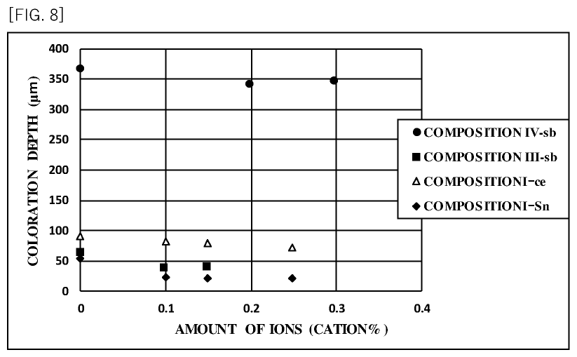

With respect to the glass samples, the transparency evaluation (external transmittance difference) of the non-colored portion, the optical density (OD) of the colored portion, the sharpness of the shape of the colored layer, and the thickness (coloration depth) of the colored layer were measured in a similar manner as described above. Results are shown in FIG. 5 to FIG. 8. In the drawings, the amount of ions represents the amount of the Sb ions, the Sb ions, or the Ce ions.

1. Glass comprising:
a colored layer,
wherein the glass contains one or more glass components selected from the group consisting of Sb ions, As ions, Sn ions, and Ce ions in an amount of 0.075 cation % or more.

2. The glass according to claim 1,
wherein Bi ions are contained as the glass component.

3. The glass according to claim 1,
wherein a refractive index is 1.70 or more.

4. The glass according to claim 1,
wherein a difference between a minimum value of a transmittance in a visible light region of the colored layer and a minimum value of a transmittance in a visible light region of a non-colored portion is 10% or more.

5. A glass article comprising:
the glass according to claim 1.

6. An optical glass comprising:
the glass according to claim 1.

7. An optical element comprising:
the glass according to claim 1.

8. The glass according to claim 1,
wherein a thickness of the colored layer is 1 to 150 μm.

9. The glass according to claim 1,
wherein an OD of a portion provided with the colored layer at a wavelength of 1100 nm is 1.0 or more,
an OD of a non-colored portion at a wavelength of 1100 nm is 0.15 or less, and
an OD decreases in combination with an increase of a wavelength in a wavelength region ranging from a visible region to a near-infrared region.

10. The glass according to claim 1,
wherein the glass is phosphate glass.

11. The glass according to claim 1,
wherein a cation ratio of the amount of B³⁺ to the amount of P⁵⁺[B³⁺/P⁵⁺] is 0.70 or less.

12. The glass according to claim 1,
wherein an amount of Bi ions is 0.5% or more.

13. The glass according to claim 1,
wherein an amount of Ti ions is 1 to 45%,
an amount of Nb ions is 1 to 45%, and
an amount of W ions is 30% or less.

14. The glass according to claim 1,
wherein a total amount of Ti ions, Nb ions, and W ions [Ti+Nb+W] is 1 to 60%.

15. The glass according to claim 1,
wherein a total amount of Ti ions, Nb ions, W ions, and Bi ions [Ti+Nb+W+Bi] is to 80%.

16. The glass according to claim 1,
wherein a cation ratio of a total amount of Ti ions, Nb ions, W ions, and Bi ions to a total amount of P⁵⁺, B³⁺, and Si⁺[(Ti+Nb+W+Bi)/(P⁵⁺+B³⁺+Si⁴⁺)] is 0.1 to 4.0.

17. The glass according to claim 1,
wherein a ratio of a value obtained by dividing a total amount of Ti ions, Nb ions, W ions, and Bi ions by the amount of Sb ions to a total amount of P⁵⁺, B³⁺, and Si⁴⁺ [{(Ti+Nb+W+Bi)/Sb}/(P⁵⁺+B³⁺+Si⁴⁺)] is 0.3 to 33.

18. The glass according to claim 1,
wherein an amount of Ta⁵⁺is 5% or less,
an amount of Li⁺is 35% or less,
an amount of Na⁺is 40% or less,
a total amount of Li⁺ and Na⁺[Li⁺+Na⁺] is 45% or less,
an amount of K⁺ is 20% or less,
an amount of Rb⁺ is 5% or less,
an amount of Cs⁺ is 5% or less,
an amount of Mg²⁺ is 15% or less,
an amount of Ca²⁺ is 15% or less,
an amount of Sr²⁺ is 15% or less,
an amount of Ba²⁺ is 25% or less,
a total amount of Mg²⁺, Ca²⁺, Sr,²⁺, and Ba²⁺ [Mg²⁺+Ca²⁺+Sr²⁺+Ba²⁺] is 30% or less,
an amount of Zn²⁺ is 15 or less,
an amount of Zr⁴⁺ is 5% or less,
an amount of Ga³⁺ is 3% or less,
an amount of In³⁺ is 3% or less,
an amount of Sc³⁺ is 3% or less,
an amount of Hf⁴⁺ is 3% or less,
an amount of Lu³⁺ is 3% or less,
an amount of Ge⁴⁺ is 3% or less,
an amount of La³⁺ is 5% or less,
an amount of Gd³⁺ is 5% or less,
an amount of Y³⁺ is 5% or less, and
an amount of Yb³⁰ is 3% or less.

19. A cover glass comprising the glass according to claim 1,
wherein the cover glass comprises a colored layer to shield light obliquely incident to a light-receiving surface of an image sensor.

20. A glass encoder comprising the glass according to claim 1,
wherein the glass encoder is a disk-shaped glass plate, and
the glass encoder comprises a plurality of the colored layers as a shutter provided with a predetermined interval at portions where both surfaces of the glass face each other, and a non-colored portion as a slit.
